(19) United States
(12) Patent Application Publication
(10) Pub. No.: US 2017/0142951 A1
(43) Pub. Date: May 25, 2017

(54) Self-Cleaning Tackle Box

(71) Applicant: Timothy J. Hardy, Virginia Beach, VA (US)

(72) Inventor: Timothy J. Hardy, Virginia Beach, VA (US)

(21) Appl. No.: 15/222,083

(22) Filed: Jul. 28, 2016

Related U.S. Application Data
(60) Provisional application No. 62/198,447, filed on Jul. 29, 2015.

(51) Int. Cl. A01K 97/06; B08B 9/08; B08B 9/093

(52) U.S. Cl. CPC A01K 97/06; B08B 9/093; B08B 9/0861

(57) ABSTRACT

The invention is a tackle box in which both the lid and the base are fitted with a clean water inlet and waste water outlet, respectively, with an optional outlet hose attached the the water outlet, so that upon entry of clean water the tackle box is configured to be self-cleaning and can be left open for a few hours or overnight to dry.

### CROSS-REFERENCE TO RELATED APPLICATION(S)

This patent application claims priority to, and incorporates herein by reference, U.S. Provisional Patent Application No. 62/198,447 filed 29 Jul. 2015.

### BACKGROUND OF THE INVENTION

Field of the Invention

The invention relates to the simple and effective in situ cleansing of tackle box contents after fishing expeditions.

Description of Related Art

Modern tackle boxes tend to be made of mostly if not completely plastic materials, unlike their metal counterparts from years and decades past. Such plastics generally include polycarbonate and other plastics which are adequately rigid for good structural performance but which are pliable enough not to crack or craze under stress. Plastic constituents in a tackle box are well designed to withstand the insult of salt water, mud or other contaminants that inevitably splash into or otherwise contaminate a tackle box during use.

Unlike the typical plastic components of a tackle box, many items forming the contents of a tackle box are particularly susceptible to deterioration or rust, especially upon contamination with salt water in particular. Many lures and baits as well as fishing line parts and accessories are made of metals which are susceptible of rust or other corrosion. Some flashy baits contain biological materials, such as hair and feathers, which when kept clean and dry are relatively shelf-stable but are otherwise vulnerable to deterioration. The traditional way to clean a tackle box after the conclusion of a fishing trip, particularly a salt water fishing trip, was to dismantle the box and clean and dry each individual item stored within the box. Because such traditional cleaning is enormously time- and labor-intensive (and virtually “no fun”) tackle box contents often suffer widespread deterioration or rust and have to be replaced between fishing trips. Even in fresh-water fishing environs, it is impossible to avoid contamination of tackle box contents by any or all of splashed mud; natural perspiration, sebum and the inevitable fish-related contaminants on the fingers; and the typical electrolytic composition of fresh water which, although not saline, is typically “hard” water containing a variety of dissolved minerals which are in their own way as troublingly corrosive as saline, to name a few.

A need therefore remains for a tackle box which is designed or equipped in such a way that it can be easily and speedily cleaned and the contents safely dried, to preserve the leftover tackle box contents in between fishing trips while enhancing the fishing experience for the user.

### SUMMARY OF THE INVENTION

In order to meet this need, the present invention is a tackle box in which both the lid and the base are fitted with a clean water inlet and waste water outlet, respectively, with an optional outlet hose attached to the water outlet. Inside the box, all of the vertical partitions are perforated, that is, are configured to allow clean flush water to pass freely through the partition walls while still containing the contents of the tackle box in each respective tackle box compartment. As a general rule—with possible exceptions—the horizontal surfaces of the compartments within the tackle box are not perforated. By introducing clean water into the clean water inlet, water flushes throughout the tackle box including through the perforated partitions, and from there waste water exits via the waste water outlet, either through the waste water outlet in the box itself, or via the waste water outlet and through the optional hose connected thereto. In a preferred embodiment of the invention, the tackle box has a false bottom (interior additional base) which is sloped at a gentle angle toward the water outlet aperture, to enhance complete drainage. As part of the present cleaning process, after the tackle box has been flushed thoroughly with clean water, the box is typically left open for a few hours to overnight to dry, and the cleaned contents do not rust or corrode because they have just been cleansed with clean, preferably deionized, water. By contrast, if tackle box contents are left in contact with contaminants inevitably introduced during any sort of fishing venture, without the present or some other cleaning process corrosion or deterioration of the tackle box contents are virtually assured.

### BRIEF DESCRIPTION OF THE DRAWINGS

FIG. 1 is a perspective view of a first embodiment of the invention, in which a clean water inlet is positioned generally in the center of the tackle box lid and the waste water outlet exits the tackle box base.

FIG. 2 is a perspective view of the tackle box of FIG. 1, but in its open and expanded position.

FIG. 3 is a perspective view of a second embodiment of the invention, showing stationery perforated partitions instead of the hinged compartments of FIG. 2.

FIG. 4 is a side sectional view of a third embodiment of the invention, showing a false bottom within the tackle box base, creating a surface which enhances downhill drainage of the flush water; and

FIG. 5 is a perspective view of a fourth embodiment of the invention, in which a central waste water outlet is positioned generally in the center of the bottom of the base of the tackle box, and for which any added outlet hose would generally be superfluous.

### DETAILED DESCRIPTION OF THE INVENTION

As described above, the present invention is a tackle box in which both the lid and the base are fitted with a clean water inlet and waste water outlet, respectively, with an optional outlet hose attached to the water outlet. Inside the box, all of the vertical partitions are perforated, that is, are configured to allow clean flush water to pass freely through the partition walls while still containing the contents of the tackle box in each respective tackle box compartment. As a general rule—with possible exceptions—the horizontal surfaces of the compartments within the tackle box are not perforated. By introducing clean water into the clean water inlet, water flushes throughout the tackle box including through the perforated partitions, and from there waste water exits via the waste water outlet, either through the waste water outlet in the box itself, or via the waste water outlet and through the optional hose connected thereto. In a preferred embodiment of the invention, the tackle box has a false bottom (interior additional base) which is sloped at a gentle angle toward the water outlet aperture, to enhance complete drainage. As part of the present cleaning process, after the tackle box has been flushed thoroughly with clean water, the box is typically left open for a few hours to overnight to dry, and the cleaned contents do not rust or corrode because they have just been cleansed with clean, preferably deionized, water. By contrast, if tackle box contents are left in contact with contaminants inevitably introduced during any sort of fishing venture, without the present or some other cleaning process corrosion or deterioration of the tackle box contents are virtually assured.

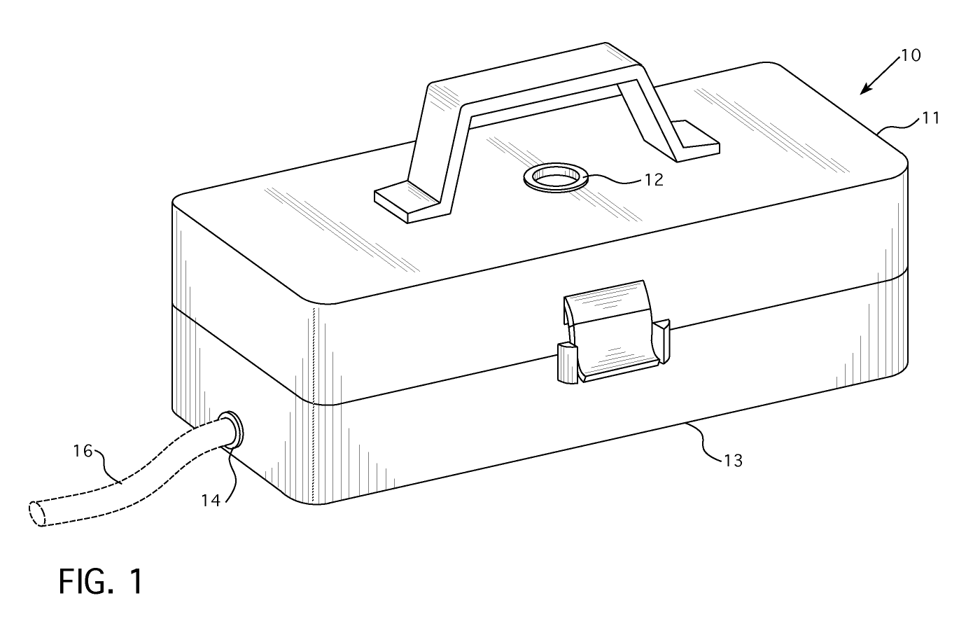

Referring now to FIG. 1, a tackle box 10 is shown in perspective view, in a closed position. The tackle box lid 11 has a clean water inlet 12 therein, generally positioned in or adjacent the center of the uppermost surface of the tackle box lid 11. A waste water outlet 14 is positioned adjacent the bottom surface of the tackle box base 13, and the waste water outlet 14 has affixed thereto an optional outlet hose 16. Although each of the clean water inlet 12 and the waste water outlet 14 structures are shown with reinforcing annular flanges forming a part thereof, these flanges are optional and the inlet and outlet can be simple apertures if desired.

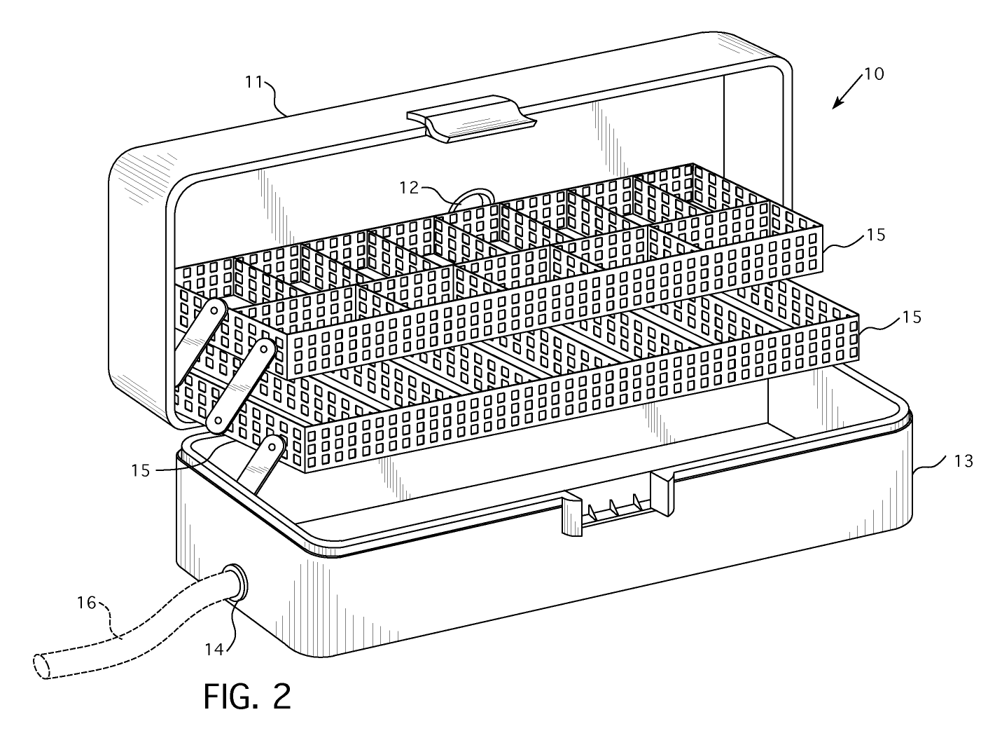

Referring now to FIG. 2, the tackle box 10 of FIG. 1 is shown in open, expanded condition to reveal the interior hinged perforated compartments 15. The key features of the perforated compartments 15 are as follows: a) the perforations are small enough to retain most or all tackle box contents within their respective compartments but large enough to allow flush water to pass through, with the perforation's size generally being between 0.5-10 mm², and more preferably between 2-5 mm²; b) generally only the vertical surfaces are perforated, that is, the horizontal walls of each tackle box compartment are typically solid; and c) although in FIG. 2 all vertical walls are shown with uniform and ubiquitous perforations, the invention embraces partial perforations of the vertical compartment walls as long as some walls in each compartment are perforated. Because the perforation size can be as small as 0.5 mm², it is possible to use actual screening material that is much finer as to its perforations than the perforations shown in FIG. 2. By keeping the perforations to a maximum size of ,say, 10 mm² or at least within an order of magnitude thereof, the wall partitions do not allow small tackle to pass through or to be lost or rearranged during cleaning of the tackle box contents. Other features of FIG. 2 parallel those of FIG. 1, namely, the tackle box lid 11, the tackle box base 13, the waste water outlet 14 and optional outlet hose 16, and of course the clean water inlet 12.

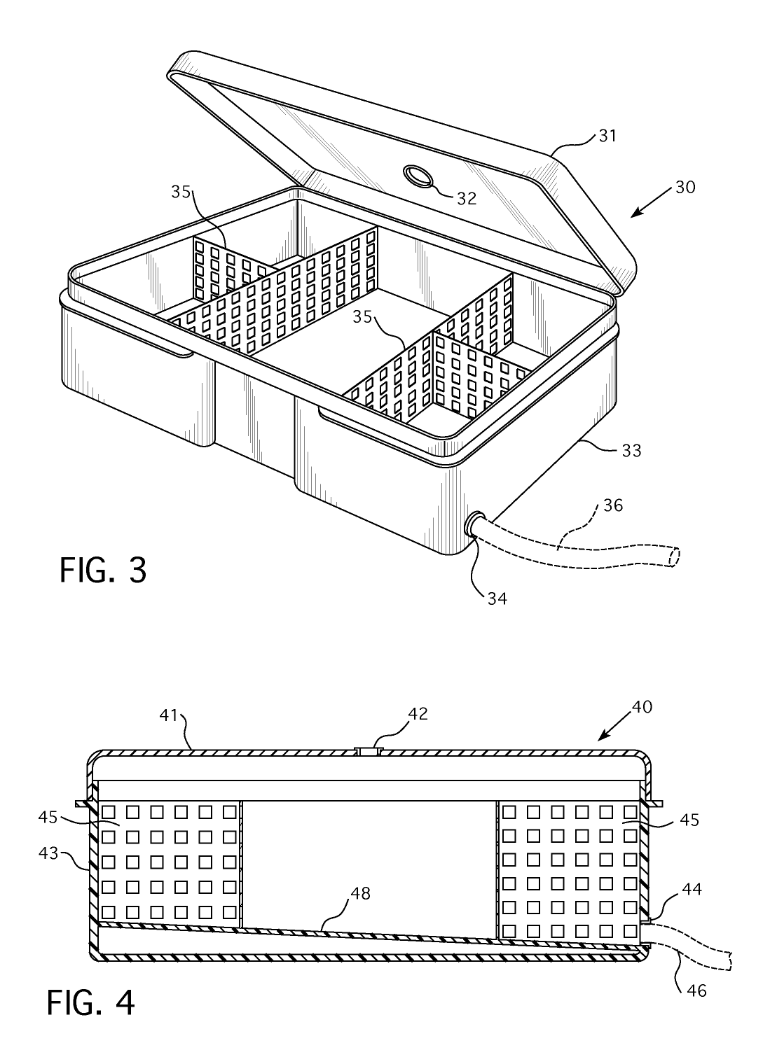

A second embodiment of the invention appears in FIG. 3. In FIG. 3, a tackle box 30 has a tackle box lid 31 bearing, generally in the center of the upper surface thereof, a clean water inlet 32. Instead of the hinged and deployable perforated compartments of FIGS. 1-2, the compartments of FIG. 3 are stationary perforated partitions 35. However, in the same way as in FIGS. 1 and 2 the waste water outlet 34 and the optional outlet hose 36 are positioned at the lower side of a vertical wall of the tackle box base 33.

FIG. 4 illustrates a third embodiment of the invention in side sectional view. The tackle box 40 has a tackle box lid 41, having in the general center thereof a clean water inlet 42. Not all the perforate partitions 45 have the same vertical dimension, however, because they fit atop a sloped, false bottom 48 (contained with the tackle box base 43) which enhances efficient downhill drainage of water to the waste water outlet 44 (and optional outlet hose 46). As soon as one grasps the concept of the present invention by consultation of this specification and drawings, for the embodiments shown in FIGS. 1, 2 and 3 one would accordingly prop up one corner or edge of the tackle box after cleaning, to promote good drainage; with the embodiment of the invention shown in FIG. 4 the tackle box can be allowed to drain and dry on any flat surface.

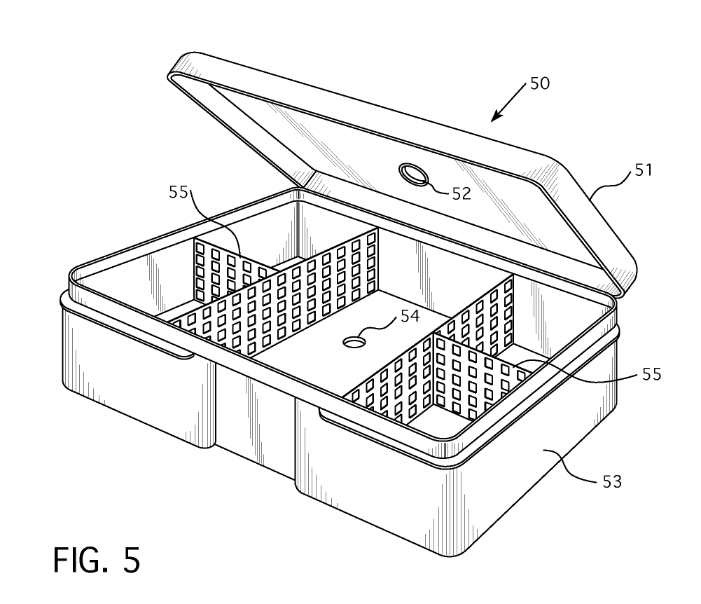

In FIG. 5, a fourth embodiment of the invention is a variant on the other three embodiments, namely, by providing a central waste water outlet 54 in the center of the bottom surface of the tackle box base 53, instead of along the bottom edge of its side. By placing the clean water inlet 52 in the general center of the top of the tackle box lid 51 and the waste water outlet 54 in the bottom surface of the tackle box base 53, and by providing perforated partitions 55 as the vertical components of the compartments within the tackle box 50, a natural Coriolis effect can take place in which the clean water, when introduced in a swirling fashion by angling the flow into the clean water inlet 52, swirls throughout the tackle box 50 and out the waste water outlet 54. The inlet and outlet dimensions as shown are exemplary but can be larger or smaller as desired. If the inlet and outlet structures are much larger than as illustrated, they will generally have a removable cap thereon (not shown). In the fourth embodiment of the invention, the otherwise optional outlet hose is ostensibly still optional, but is usually superfluous and is not shown in FIG. 5. The embodiment of FIG. 5 can also have a false bottom, similar to 48 of FIG. 4, except that the angle or slope of the FIG. 5 false bottom (not shown) would be towards the center, analogously to a shower stall floor.

There are other ways of configuring self-cleaning tackle boxes that are contemplated as part of the present invention. Instead of a common cavity within the tackle box, which is cleaned and flushed all together at the same time, it is possible to configure the interior compartments so that they flush in a more prescribed, multiple conduit configuration. Having said that, however, the embodiments shown in the Figures are preferred because they drain more quickly and completely than more complicated conduits or water paths could possibly drain. Therefore, a common features among all the embodiments of the invention is that the entire tackle box is configured—with ample perforations in an adequate number of interior vertical partitions—for cleaning by flushing with clean water in an operation that cleans the entire tackle box and its content all at once. For similar reasons, even though it is possible to attach a number of the present tackle boxes in series so that a continuous stream of water enters and exits all of the tackle boxes from a single water source, in practice it is preferred that every tackle box be cleaned with a starting stream of clean water and so the cleaning of each tackle box by itself is the preferred practice of the invention.

Although the invention has been described with particularity above, with specific reference to individual structures and even certain dimensions, the invention is only to be limited insofar as is set forth in the accompanying claims.

We claim:

1. A tackle box, comprising a base, a lid, and at least one substantially vertical partition therein, wherein said at least one vertical partition contains perforations therein, and further wherein said lid contains a clean water inlet and said base contains a waste water outlet.

2. The tackle box of claim 1, wherein said waste water outlet has an outlet hose attached thereto.

3. The tackle box of claim 1, wherein at least four substantially vertical partitions contain perforations within said tackle box.

4. The tackle box of claim 1, wherein said waste water outlet is positioned on an outer vertical wall of said base near the lowermost edge.

5. The tackle box of claim 1, wherein said clean water inlet is positioned generally in the center of the uppermost surface of said lid.

6. The tackle box of claim 1, wherein said waste water outlet is positioned generally in the center of the lowermost surface of the base.

7. The tackle box of claim 1, wherein said base contains a false bottom which is slanted from the horizontal, so as to encourage drainage of water via gravity in the direction of the waste water outlet.

8. The tackle box of claim 1, wherein said perforations have the dimension of approximately 0.5-10 mm².

9. The tackle box of claim 1, wherein said perforations have the dimension of approximately 2-5 mm².

10. The tackle box of claim 1, wherein substantially all structures thereof are constructed of a plastic material.
